(19) United States
(12) Patent Application Publication
(10) Pub. No.: US 2016/0236203 A1
(43) Pub. Date: Aug. 18, 2016

(54) Refining of sand to remove impurities

(71) Applicant: Russell Wynn Driver, Irving, TX (US)

(72) Inventor: Russell Wynn Driver, Irving, TX (US)

(21) Appl. No.: 14/998,472

(22) Filed: Jan. 8, 2016

Related U.S. Application Data
(60) Provisional application No. 62/125,076, filed on Jan. 12, 2015.

(51) Int. Cl. B02C 23/08; E21B 43/267; B02C 19/06

(52) U.S. Cl. CPC B02C 23/08; B02C 19/06; E21B 43/267

(57) ABSTRACT

Sand containing impurities that weaken its suitability as a proppant in well boreholes can be refined by the process of (1) drying the sand to remove moisture, (2) grinding the sand in a jet mill to create particle-on-particle contact of the sand and impurity grains, and (3) removing pulverized impurities from the sand by blowing the sand with air or by processing the sand in a mineral separator. The sand can then be used in a borehole as a proppant and in fracking. The sand can be screened at any point in the process to separate the sand particles by grain size. The refined sand can be coated with a resin after the removal of pulverized impurities.

### CROSS-REFERENCE TO RELATED APPLICATIONS

The present application claims the benefit of 35 U.S.C. §111(b) U.S. Provisional Application Ser. No. 62/125,076, filed Jan. 12, 2015, entitled “Refining of Sand to Remove Impurities”.

### STATEMENT REGARDING FEDERALLY-SPONSORED RESEARCH OR DEVELOPMENT

Not Applicable

### THE NAMES OF THE PARTIES TO A JOINT RESEARCH AGREEMENT

Not Applicable

### INCORPORATION-BY-REFERENCE OF MATERIALS ON A COMPACT DISC

Not Applicable

### BACKGROUND OF THE INVENTION

1. Field of the Invention

This invention relates to the art of refining sand to remove impurities from the sand in order to make the refined sand more suitable for use as a proppant and for other underground borehole purposes.

2. Description of Related Art

The production of oil and natural gas through wellbores has been aided by hydraulic fracturing, which is a stimulation technique in which underground rock formations are fractured by a hydraulically pressurized liquid. Hydraulic fracturing is often called “fracking”. A fluid comprising water, chemicals, gel, and sand suspended is injected into the underground rock formation through a wellbore under pressure. The pressurized fluid can create fractures and cracks in the rock formations, which allow oil and natural gas to flow to the wellbore and be pumped out of the ground. The hydraulic pressure of the fracturing fluid is usually replaced with hydraulic fracturing proppants to keep the rock fractures open. These proppants often comprise fine-grain sand. Since the proppants are placed far underground, they must have a high crush strength to keep open the fractured rock. The further underground they are placed, the higher the crush strength that is needed.

Sand is a naturally occurring granular material composed of finely divided rock and mineral particles. Sand is composed primarily of silica (silicon dioxide, SiO₂) which is usually in the form of quartz. Sand may also comprise calcium carbonate (CaCO₃) created from ancient coral and shellfish. Sand particles are considered to range in size from 1/16 mm to 2 mm in diameter.

Sand is a critical component in the fracturing and proppant operation. Fracking sand is tested and graded on American Petroleum Institute or International Standards Organization standards. According to those standards, the three main characteristics of fracking sand are the roundness of the sand grains, the sphericity of the sand grains, and the crush strength of the sand. Pure sand without impurities is quite hard and makes good proppant material. However, sand often has impurities mixed in with it. The impurities are usually softer than the sand and reduce its crush strength and its suitability as a fracturing proppant.

Most sands found naturally in the southern United States are alluvial deposits that contain many impurities such as feldspar, chert, and the like. These impurities are relatively soft compared to the sand particles, and this relative softness reduces the sand's crush strength. For the purpose of fracking and proppant operations, any material intermixed with sand that reduces the crush strength of the mix is considered to be an impurity, and it would be desired to remove these impurities. Removing impurities or adding pure sand to a mix usually improves its crush strength and suitability for fracking and proppant operations down-hole.

The sand found in the northern United States, particularly in Wisconsin and Minnesota, contains much less impurities than the sand found in other parts of the country, and it is considered to be the best fracking and proppant sand available in the United States. However, there is little hydrocarbon production in these northern parts of the U.S. The sand that can be mined locally in hydrocarbon producing areas of the U.S. is usually of poor quality with significant amounts of impurities in it. Companies that engage in fracking and proppant operations in borehole operations frequently have sand shipped from locations where the sand is of high quality, such as Wisconsin and Minnesota, to the area where fracking and proppant operations take place. However, transporting sand long distances is expensive.

It would be desirable if the sand found in locations where wellbores are drilled and where fracking operations require sand for fracking and proppants could be refined to eliminate some of its impurities to give it greater crush strength. This would minimize the need to transport sand from Wisconsin and Minnesota to the hydrocarbon producing areas, and would reduce the cost of fracking operations in hydrocarbon production. It would further be desirable if the refining of sand could be done at less expense than that of transporting sand from Wisconsin and Minnesota to hydrocarbon producing areas, such as Arkansas and Texas. The problems discussed here may occur in other parts of the world. The invention disclosed in this application can be applied anywhere in the world.

### DESCRIPTION OF THE INVENTION

I have invented a process for refining unrefined impure sand to be used in fracking operations and as a proppant. The local sand can be mined and crushed as is currently known. My new process comprises first drying the unrefined impure sand to remove most of the moisture in the sand (if the sand is relatively moist), then grinding the sand to generate particle-on-particle impact which tends to pulverize much of the impurities in the sand without adversely affecting the actual sand particles, then either (1) using a stream of air to blow out the pulverized impurities from the sand, or (2) running the sand through a mineral separator to remove the pulverized impurities, or (3) both sequentially.

Optionally, one may screen the sand to separate the sand by grain size at any point during my process. Also, optionally, after using a stream of air to blow out the pulverized impurities from the sand or running the sand through a mineral separator, the purified sand can be coated with a resin to increase its crush strength. Resin-coated sand can be useful at well depths where uncoated sand has insufficient crush strength to withstand the pressure at that depth. When the sand grains are to be coated with a resin, it is desirable that the sand grains be as round and spherical as is practically possible. In this case, the sand can be left in the jet mill for a longer time to obtain greater roundness and sphericity.

Once processed in this novel manner, the sand can be used in fracking and proppant operations as is known. My new process provides sand with less impurities and greater crush strength, and minimizes the need to transport sand long distances or use sand of lesser quality.

In addition to removing impurities from the impure sand, the step of grinding the sand to generate particle-on-particle impact tends to increase the rounding and sphericity of the sand particles, which may tend to increase the crush strength of the processed sand.

As to the step of either (1) using a stream of air to blow out the pulverized impurities from the sand, or (2) running the sand through a mineral separator to remove the pulverized impurities, these two alternatives are the only relatively economical means known to me of removing the pulverized impurities from the sand. However, any other means that economically removes impurities once they are pulverized would accomplish the purpose of this invention and would fall within the scope of this disclosure.

Blowing impurities out of sand, once the impurities are pulverized, can be accomplished by blowing a stream of air through the mix of sand and impurities as the mix is moved. The pulverized impurities are usually lighter than the sand particles and the air will blow them further than sand particles enabling separation of the impurities from the sand. It is known to remove pulverized impurities from sand by processing the mix in a mineral separator.

The step of grinding the dried unrefined impure sand can be accomplished by placing the dried unrefined impure sand into a “jet mill” that employs a fluid energy grinding system to generate particle-on-particle impact. The Micronizer® jet mill made by Sturtevant Inc. is an example of the type of jet mill that can be utilized to grind the unrefined impure sand and pulverize the impurities in the impure sand. The Micronizer® device is a jet mill that uses aligned jets of compressed air or gas to create a vortex within a chamber. Material to be ground is fed into the vortex along an engineered tangent circle and rotated at high speed. The material within the vortex is subjected to particle-on-particle contact. Centrifugal force causes larger particles to move toward the perimeter of the vortex and smaller particles to move toward the center of the vortex. A vortex finder at the center of the device can allow fine particles to exit the vortex. One can either allow the jet mill to run until all the lighter pulverized impurities have exited the exit at the center of the Micronizer® jet mill, or alternatively one can simply run the jet mill for a given period of time that is known to remove a sufficient percentage of the impurities and then the jet mill can be stopped and the refined sand removed. Processing the sand in the jet mill may also increase the roundness and sphericity of the sand particles, which is desirable as long as the average size of the sand particles is not decreased beyond the point of being useful. Persons of ordinary skill in this art may choose to process sand in a jet mill for a relatively shorter time and obtain larger sand particles with less roundness and sphericity; others may choose to process sand in a jet mill for a relatively longer time and obtain small sand particles with more roundness and sphericity. The choice of processing time will be a matter of design choice that will be within the capability of a person of ordinary skill in this art who has read this entire disclosure. It should be understood, however, that the primary purpose of processing the sand in the jet mill is to pulverize impurities so that they can be removed.

Jet mills such as the Micronizer® are known and used primarily in the food industry. I am unaware of anyone placing unrefined impure sand in a jet mill prior to my invention for the purpose of removing impurities from the sand. Jet mills are also called fluid energy mills. Known jet mills are relatively small and would accommodate only small batches of sand. However, it is possible to build much larger jet mills than are now produced based on the same principles, so that relatively large batches of sand could be ground in the jet mill. It is also possible to utilize an array of multiple jet mills sequentially or simultaneously.

By pulverizing and blowing at least some of the impurities in sand, the crush strength of the resulting processed sand is improved making it more suitable for use in fracking and proppant operations. One test batch of impure sand processed according to my invention utilizing a Micronizer® jet mill went from a crush strength of 5000 PSI before processing to 7000 PSI after processing, which is a substantial increase in crush strength. The processed sand also seemed to have greater roundness and sphericity after processing.

I claim:

1. A process for refining sand comprising the steps of:
1) drying the sand to remove moisture in the sand;
2) grinding the sand;
3) removing pulverized impurities by one of the following steps:
a) flowing a stream of air into the sand to blow out the impurities;
b) processing the sand in a mineral separator;
c) flowing a stream of air into the sand and then processing the sand in a mineral separator; and
d) processing the sand in a mineral separator and then flowing a stream of air into the sand.

2. The process for refining sand of claim 1 wherein the step of grinding the sand is accomplished by placing the sand in a jet mill to generate particle-on-particle impact.

3. The process for refining sand of claim 1 further including the step of screening the sand to separate the sand particles by grain size, the screening step occurring at any point in the process.

4. The process for refining sand of claim 1 further including, after the step of removing pulverized impurities, the step of coating the sand with a resin.

5. The process for refining sand of claim 1 further including, after the step of removing pulverized impurities, the step of placing the refined sand into an underground wellbore for the purpose of acting as a proppant or to aid in fracturing an underground rock formation.
